(19) United States
(12) Patent Application Publication
(10) Pub. No.: US 2005/0095982 A1
(43) Pub. Date: May 5, 2005

(54) MSS user equipment and methods for synchronizing MSS user equipment

(76) Inventors: Scott D. Blanchard, Mesa, AZ (US); Dean Paul Vanden Heuvel, Chandler, AZ (US); Daniel B. Bossler, Chandler, AZ (US)

Correspondence Address: INGRASSIA FISHER & LORENZ, P.C., 7150 E. CAMELBACK, STE. 325, SCOTTSDALE, AZ, 85251, US

(21) Appl. No.: 10/703,003

(22) Filed: Nov. 5, 2003

(51) Int. Cl. H04B 7/185

(52) U.S. Cl. 455/12.1

(57) ABSTRACT

User Equipment (UE) and methods for UE synchronization are provided in accordance with the present invention. The UE is configured for operation in a Mobile Satellite System (MSS) that has satellites that are configured to couple the UE to a ground station. The UE includes a transceiver that is configured to couple the UE to at least one of the plurality of satellites and a controller coupled to the transceiver. The controller is configured to perform one or more operations that result in an adjustment of the UE timing reference.

### TECHNICAL FIELD

The present invention generally relates to satellite communication systems, and more particularly to User Equipment (UE) and methods for synchronizing UE in a mobile satellite communication system, which is also generally referred to as a Mobile Satellite System (MSS).

### BACKGROUND

Mobile satellite communication systems have continued to evolve and have become an important component of modem society. Mobile satellite communication systems support numerous applications such as worldwide television, remote area communications, wide area data network communications, global personal communication to hand-held portable communication devices (e.g., telephones), broadband voice communication, video communication and/or communication of any number of data types. As the number of applications supported by mobile satellite communication systems has increased and the number of users using these applications has increased, processes have been developed to accommodate the increased number of applications and users.

Multiplexing is one such process that has been developed to accommodate the increase in the number of applications and users in communication systems. The process of multiplexing allows multiple signals to be sent on a single channel, and many forms of multiplexing have been developed to generate a multiplexed communication signal. For example, time multiplexing, frequency multiplexing, space multiplexing (e.g., Frequency-Division Multiplexing (FDM), Time-Division Multiplexing (TDM), Space-Division Multiplexing (SDM), Orthogonal Frequency Multiplexing (OFM), Code-Division Multiple Access (CDMA) multiplexing, Wideband Code-Division Multiple Access (WCDMA) multiplexing, Time-Division Multiple Access multiplexing (TDMA), Orthogonal Frequency Multiple Access (OFMA) multiplexing, and Frequency Division Multiple Access multiplexing (FDMA)) have been developed to generate a multiplexed communication signal.

Multiplexing in mobile satellite communication systems is generally based upon terrestrial communication system standards (e.g., Personal Communication Services (PCS) standards such as the air Interim Standard (IS)-2000 and the Universal Mobile Telecommunications Service (UMTS)). The terrestrial communication system standards generally support a framing structure that assumes a minimal round trip time delay uncertainty (e.g., less than one (1) millisecond (msec)), which is attributable to terrestrial cell sizes. However, the assumption of a minimal round trip delay uncertainty is not always applicable in mobile satellite communication systems as the round trip time delay uncertainty of a mobile satellite communication system (e.g., greater than one (1) msec and generally can be in the range of about twenty (20) msec to about three hundred (300) msec and greater) can be significantly greater than the round trip delay uncertainty of terrestrial communication systems and can also vary significantly between individual User Equipment (UE) in the mobile satellite communication system (e.g., the round trip delay uncertainty can be one or more milliseconds to tens of milliseconds and greater). Therefore, the relative frame timing between a ground station and UE in a mobile satellite communication system is unknown to a greater extent than the relative frame timing between a terrestrial cell and UE in a terrestrial communication system, and less than desirable synchronization can result with this increase in the uncertainty of the relative framing timing.

In view of the foregoing, it should be appreciated that it would be desirable to provide methods for synchronizing MSS UE. In addition, it would be desirable to provide MSS UE that synchronizes in a MSS. Furthermore, additional desirable features provided by the invention will become apparent to one skilled in the art from the drawings, foregoing background, following detailed description and appended claims.

### BRIEF SUMMARY

User Equipment (UE) is provided in accordance with an exemplary embodiment of the present invention that is configured for operation in a Satellite System (MSS) that has satellites that are configured to couple the UE to a ground station. The UE comprises a transceiver that is configured to couple the UE to at least one of the satellites and a controller coupled to the transceiver. The controller is configured to determine a position of the UE, receive information associated with a position of the satellite from a broadcast channel transmission of the ground station, receive a position of the ground station from the broadcast channel transmission of the ground station, calculate a delay with the position of the UE, the information associated with the position of the satellite and the position of the ground station and adjust a reference timing of the UE by the delay.

A method of operating a User Equipment (UE) for synchronizing in a Mobile Satellite System (MSS) having the satellites and a ground station is also provided in accordance with an exemplary embodiment of the present invention. The method comprises the steps of determining a position of the UE, receiving information associated with a position of the satellite from a broadcast channel transmission of the ground station, receiving a position of the ground station from the broadcast channel transmission of the ground station, calculating a delay with the position of the UE, the information associated with the position of the satellite and the position of the ground station and adjusting a reference timing of the UE by the delay.

User Equipment (UE) is provided in accordance with another exemplary embodiment of the present invention that is configured for operation in a Satellite System (MSS) that has satellites that are configured to couple the UE to a ground station. The UE comprises a transceiver that is configured to couple the UE to at least one of the satellites and a controller coupled to the transceiver. The controller is configured to receive a timing signal transmitted by the ground station to at least one of the plurality of satellites and forwarded by the at least one of the satellites, return the timing signal to the ground station, receive a delay determined based in at least in part from a measurement of a period for the timing signal to travel from the ground station to the at least one of the satellites and from the at least one of the satellites to the UE and adjust a reference timing of the UE by the delay.

A method of operating a User Equipment (UE) for synchronizing in a Mobile Satellite System (MSS) having the satellites and a ground station is also provided in accordance with another exemplary embodiment of the present invention. The method comprises the steps of receiving a timing signal transmitted by the ground station to at least one of the satellites and forwarded by the at least one of the satellites, returning the timing signal to the ground station, receiving a delay determined based in at least in part from a measurement of a period for the timing signal to travel from the ground station to the at least one of the satellites and from the at least one of the satellites to the UE and adjusting a reference timing of the UE by the delay.

User Equipment (UE) is provided in accordance with yet another exemplary embodiment of the present invention that is configured for operation in a Satellite System (MSS) that has satellites that are configured to couple the UE to a ground station. The UE comprises a transceiver that is configured to couple the UE to at least one of the satellites and a controller coupled to the transceiver. The controller is configured to receive a timing signal transmitted by the ground station and forwarded by at least one of the satellites with the timing signal having a first time of a reference time of the MSS corresponding to transmission of the timing signal by the ground station. The controller is also configured to receive a second time of the reference time of the MSS corresponding to the receiving the timing signal transmitted by the ground station and forwarded by the at least one of the satellites, determine a time delay that is based at least in part on the first time and the second time and adjust a reference timing of the UE by the time delay.

A method of operating a User Equipment (UE) for synchronizing in a Mobile Satellite System (MSS) having the satellites and a ground station is also provided in accordance with yet another exemplary embodiment of the present invention. The method comprises the steps of receiving a timing signal transmitted by the ground station and forwarded by at least one of the satellites with the timing signal having a first time of a reference time of the MSS corresponding to transmission of the timing signal by the ground station. The method also comprises the steps of receiving a second time of the reference time of the MSS corresponding to the receiving the timing signal transmitted by the ground station and forwarded by at least one of the satellites, determining a time delay that is based at least in part on the first time and the second time and adjusting a reference timing of the UE by the time delay.

### BRIEF DESCRIPTION OF THE DRAWINGS

The present invention will hereinafter be described in conjunction with the following drawing figures, wherein like numerals denote like elements, and

FIG. 1 is a simplified illustration of a mobile satellite communication system or MSS according to a preferred exemplary embodiment of the present invention;

FIG. 2 is a simplified illustration of MSS UE that is configured to provide synchronization in accordance with an exemplary embodiment of the present invention;

FIG. 3 is a method of operating the MSS UE of FIG. 2 for synchronizing in the MSS of FIG. 1 in accordance with a first exemplary embodiment of the present invention;

FIG. 4 is a method of operating the MSS UE of FIG. 2 for synchronizing in the MSS of FIG. 1 in accordance with a second exemplary embodiment of the present invention; and

FIG. 5 is a method of operating the MSS UE of FIG. 2 for synchronizing in the MSS of FIG. 1 in accordance with a third exemplary embodiment of the present invention.

### DETAILED DESCRIPTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

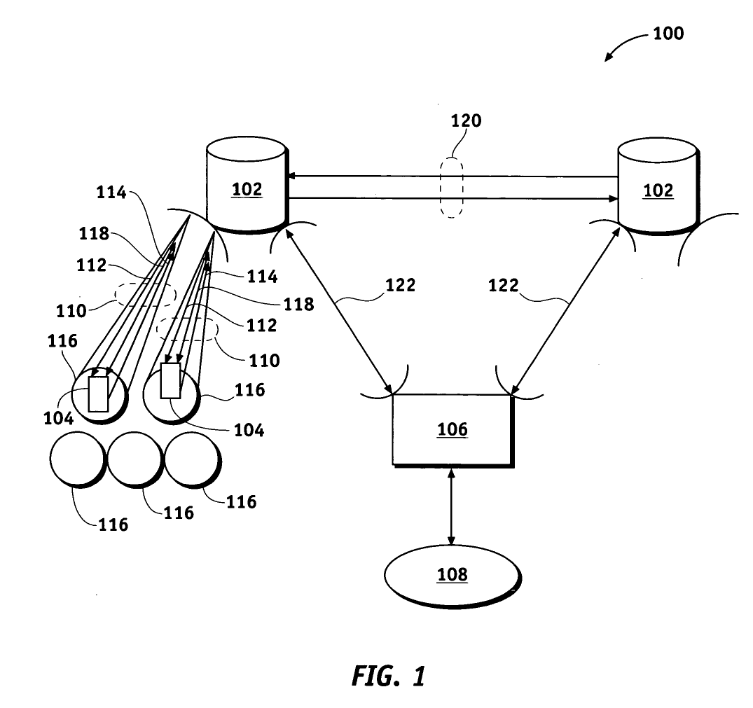

Referring to FIG. 1, a simplified illustration of a mobile satellite communication system or MSS 100 is presented according to an exemplary embodiment of the present invention. As can be appreciated by one of ordinary skill in the art, the MSS 100 can be configured to support numerous communication applications. For example, the MSS 100 can be configured to support global personal communication to hand-held portable communication devices (e.g., telephones), broadband voice communication, video communication, radio, cable television (CATV), telephony as well as other data, voice video or a combination data, video and/or voice communications as worldwide television, remote area communications, wide area data network communications.

The MSS 100 includes at least one satellite 102, and preferably includes multiple satellites 102 forming a satellite constellation. The satellites 102 are preferably located in a geosynchronous orbit (GEO) relative to a celestial body, such as the earth. However, the satellites 102 can be located in any number of orbits relative to a celestial body according to the present invention. For example, the satellites 102 can be located in a low earth orbit (LEO), medium earth orbit (MEO), and/or a polar orbit as known to those of ordinary skill in the art.

The satellite 102 or satellites 102 of the MSS 100 couple the User Equipment (UE) 104 and the ground station 106 and the ground station 106 couples one or more elements of the MSS 100 to other communication systems (not shown) or a single network 108 or multiple networks. For example, the ground station 106 can couple the one or more elements of the MSS 100 to public networks, cellular networks, and/or private networks (e.g., Public Switched Telephone Network (PSTN) and the Public Land Mobile Network (PLMN)).

The UE 104 is preferably coupled to the satellite 102 or satellites 102 with subscriber links 110. The subscriber links 110 encompass a portion of the electromagnetic spectrum (e.g., UHF or L-Band frequency bands) that are divided into numerous channels and are preferably combinations of frequency channels that encompass a multiplexing scheme such as time multiplexing, frequency multiplexing, space multiplexing (e.g., Frequency-Division Multiplexing (FDM), Time-Division Multiplexing (TDM), Space-Division Multiplexing (SDM), Orthogonal Frequency Multiplexing (OFM), Code-Division Multiple Access (CDMA) multiplexing, Wideband Code-Division Multiple Access (WCDMA) multiplexing, Time-Division Multiple Access (TDMA) multiplexing, Orthogonal Frequency Multiple Access (OFMA) multiplexing, Frequency Division Multiple Access (FDMA) multiplexing and/or combinations of two or more of these multiplexing schemes.

The satellites 102 generally transmit over one or more broadcast channels 112 and the UE 104 monitors the broadcast channels 112 to detect data messages address to the UE 104. The data messages addressed to the UE 104 include both ring-alerts, which notify the UE 104 that another party desires to establish a communication session with the UE 104. In addition, the broadcast channels 112 deliver specific messages and data as subsequently described in this detailed description. The UE 104 can transmit messages to satellites 102 over one or more acquisition channels 114. The broadcast channels 112 and acquisition channels 114 are typically not dedicated to any one UE 104, but are generally shared by more than one UE 114 within a footprint 116 of a satellite 102.

In contrast to the non-dedicated acquisition channels 114 and broadcast channels 112, a dedicated traffic channel 118 is usually provided between the UE 104 and the one or more satellites 102. The traffic channels 118 are bi-directional channels that are assigned to a particular UE 26 by one or more satellites 102 from time to time. In an exemplary embodiment, a digital format is used to communicate data over the traffic channels 118, broadcast channels 112 and acquisition channels 114, and traffic channels 118 support real-time communications. Preferably, at least one traffic channel 118 is assigned for each communication session, and each traffic channel 118 has sufficient bandwidth to support, as a minimum, a two-way voice conversation in accordance with one or more multiplexing schemes as previously described in this detailed description. More preferably, each satellite 102 supports up to a thousand or more traffic channels 118 so that each satellite 102 can simultaneously service a like number of independent calls.

Satellites 102 preferably communicate with other satellites 102 through cross-links 120. Accordingly, a signal from the UE 104 can be routed through the constellation of satellites 102 to within range of substantially any other location. For example, a signal can be routed to the UE 104 on or near the surface of the earth from a satellite 102 using a subscriber link 110 as known to those of ordinary skill in the art. Alternatively, a signal can be routed to the UE 104 from the ground station 106 through earth links 122. The ground station 106 can include, a System Control Segment (SCS), which monitor the health and status of the MSS 100, Gateways (GW) and/or earth terminals. However, any number of alternative configurations of an MSS can be used in accordance with the present invention, which route the incoming and outgoing signals of the UE 104.

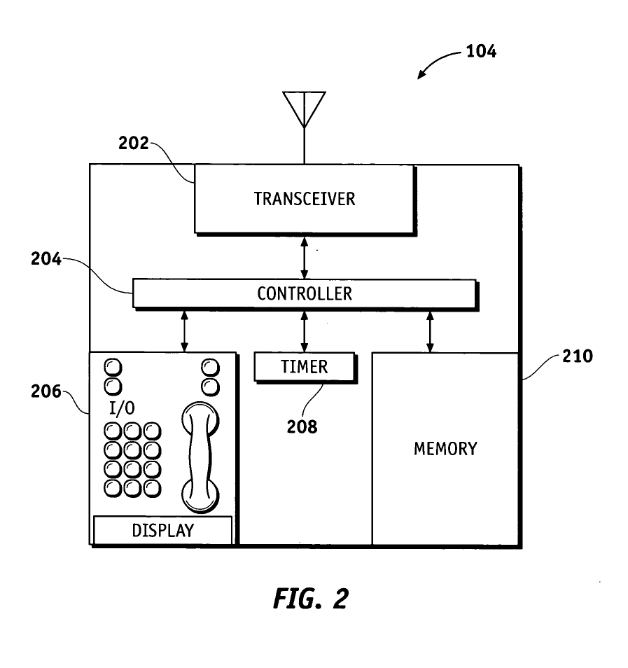

Referring to FIG. 2, a UE 104 is illustrated in accordance with an exemplary embodiment of the present invention. The UE 104 comprises a transceiver 202 that is configured to transmit and receive the incoming and outgoing signals from the one or more satellites 102 of the MSS 100 as shown in FIG. 1 and previously described in this detailed description. The transceiver 202 is preferably a multi-channel transceiver capable of transmitting and receiving on at least a majority of the channels, preferably on substantially all the channels, and more preferably on all the channels as set forth in a selected multiplexing scheme. The transceiver 202 preferably comprises an acquisition channel transceiver (not shown), a broadcast channel receiver (not shown) and a traffic channel transceiver (not shown). The acquisition channel transceiver communicates on one of several acquisition channels as preferably specified by the satellite and is primarily used during access protocols when the UE 104 seeks access to the MSS 100 as known to those of ordinary skill in the art. The traffic channel transceiver portion communicates with the MSS 100 on a traffic channel preferably assigned by satellite, and those of ordinary skill in the art will understand that the acquisition channel transceiver, the broadcast channel receiver and the traffic channel transceiver can be contained in one unit capable of all three functions or divided into individual units or formed of multiple subunits.

The transceiver 202 is coupled to a controller 204, which can comprise a single processor or multiple processors formed of hardware, software, firmware or a combination of hardware, software, and/or firmware. The controller 204 is also preferably coupled to Input/Output (I/O) 206, timer 208, and/or memory 210. The memory 210 can be any number of storage devices, such as a magnetic storage device that can store data and/or instructions for operation of the controller 204. The controller 204 is preferably configured to control a number of functions of the UE 104, which includes that control of the UE 104 parameters, including, but not limited to timing parameters for synchronization of the UE 104 in the MSS 100 (i.e., aligning the frame timing in the system).

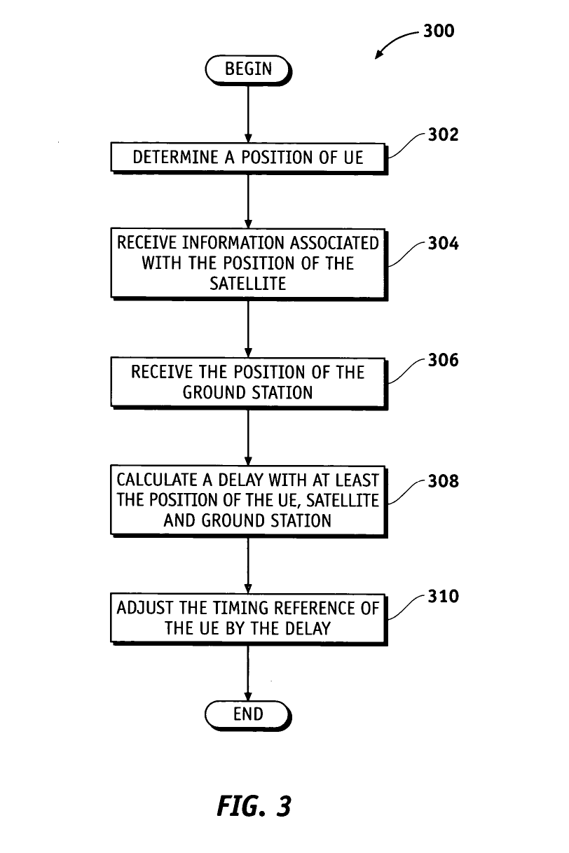

Referring to FIG. 3, a method 300 of operating the UE 104 of FIG. 2 is illustrated for synchronization in the MSS 100. Preferably, the method 300 and apparatus of the present invention and subsequently described methods and apparatus (i.e., method 400 and method 500 and the associated apparatus) are utilized in an MSS having a round trip time delay uncertainty that is greater than about one (1) msec, more preferably greater than about ten (10) msecs, and even more preferably greater than about twenty (20) msecs. In addition, the method 300 and subsequently described methods are preferably conducted during the acquisition process (i.e., establishment of a communication link between the satellite and the UE), which can include registration with the MSS 100, call set-up procedures, answering call terminations and/or determining the correct downlink time-slot. However, the method 300 and subsequently described methods can be utilized in an MSS having other round trip time delay uncertainties and conducted at other operating intervals of the UE.

The method 300 includes determining a position of the UE 302. As can be appreciated by those of ordinary skill in the art, determining the position of the UE 302 can be accomplished using any number of techniques and apparatus. For example, in accordance with a preferred exemplary embodiment, the transceiver 202 of the UE 104 as shown in FIG. 2 includes a Global Positioning System (GPS) receiver that is configured to receive GPS signals from one or more satellites of the GPS satellite constellation and further configured to determine the position of the UE based at least in part upon the GPS. As well known to those of ordinary skill in the art, the GPS is a space-based radio-navigation system that has multiple satellites and ground support, which provides users with information about position, velocity and time. However, other techniques can be used to determine the position of the UE in accordance with the present invention.

In addition to determining the position of the UE 302, the method 300 includes receiving information associated with the position of the satellite 304. The information associated with the position of the satellite 304 can originate from the ground station or alternatively originate from the satellite and the information associated with the position of the satellite is preferably received on the broadcast channel. However, the UE can receive the information associated with the position of the satellite on other channels received by the UE.

The information associated with the position of the satellite can be the actual or estimated position provided by the satellite or the ground station. Alternatively, the information associated with the position of the satellite can be one or more parameters that the UE can use to calculate the position. For example, the information associated with the position of the satellite can be the orbital parameters of the satellite, which can be use by the UE to calculate the current position in accordance with techniques known to those of ordinary skill in the art.

In addition to receiving the information associated with the satellite 304, the UE receives the position of the ground station 306. The position of the ground station can originate from the ground station or alternatively the UE can receive an identifier for the ground station that is associated with position information stored in the memory 210 of the UE 104 as shown in FIG. 2. The position or identifier of the UE can originate from the ground station and the UE preferably receives the information on the broadcast channel. However, the ground station position or identifier can be received on other channels received by the UE. Alternatively, the ground station or the satellite can determine or receive information of the position of the UE, determine or receive information associated with the position of the satellite, and determine or receive information associated with the position of the ground station and send the delay to the UE after the delay is calculated that is based at least in part on the position of the UE, position of the satellite and position of the ground station.

Once the position of the UE, position of the satellite and position of the ground station is determined in the method 300, the method 300 calculates a delay with at least the position of the UE, the position of the satellite and the position of the ground station 306. For example, if the position of the ground station (X_{GS},Y_{GS},Z_{GS}), the position of the satellite (X_{Satellite},Y_{Satellite},Z_{Satellite}) and the position of the UE (X_{UE},Y_{UE},Z_{UE})are known, the distance between the ground station (D_{GS-Satellite}), the distance between the satellite and the UE (D_{Satellite-UE}) and the total distance between the ground station and the UE via the satellite (Dₜₒₜₐₗ=D_{GS-Satellite}+D_{Satellite-UE}) can be determined as set forth in equation (1), equation (2) and equation (3), respectively, as follows:
D_{GS-Satellite}=((X_{GS}−X_{Satellite})²+(Y_{GS}−Y_{Satellite})²+(Z_{GS}−Z_{Satellite})²)^{1/2} (1)
D_{Satellite-UE}=((X_{Satellite}−X_{UE})²+(Y_{Satellite}−Y_{UE})²+(Z_{Satellite}−Z_{UE})²)^{1/2} (2)
Dₜₒₜₐₗ=D_{GS-Satellite}+D_{Satellite-UE} (3)
Accordingly, a substantially accurate calculation of the delay associated with the travel time of an electromagnetic wave from the ground station to the satellite and from the satellite to the ground station can be calculated as set forth in equation (3) as follows:
Delay =c/Dₜₒₜₐₗ (4)
Where c is the speed of light (i.e., 2.997924574 ×10⁸ m/s). However other techniques can be used to calculate the delay associated with the travel time of an electromagnetic wave from the ground station to the satellite and from the satellite to the ground station in accordance with the present invention and other values can be used for the speed of light to account for the medium in which the electromagnetic wave is traveling as known to those of ordinary skill in the art. In addition, other delay components can be included in the calculation of the delay 306, such as delays associated with activities of the ground station, satellite and/or UE.

For example, the method 300 can include receiving a backend delay of the ground station 308 that can originate from the ground station or originate from the satellite, and preferably received by the UE on the broadcast channel. However, the UE can store other delays or receive the information associated with the position of the satellite on other channels received by the UE. In addition, the backend delay of the ground station or other delays can be the actual or estimated delay from one or more parameters that the UE can use to calculate or estimate the delay.

Once the UE has calculated the delay using the backend delay or has calculated the delay without the backend delay, the reference timing of the UE is adjusted by the delay. For example, if the delay is about two hundred and fifty (250) msec, the UE adjusts its transmit timing to be about five hundred (500) msec in advance of the received framing from the satellite so that the ground station will generally receive the UE signal frame aligned with the transmit frame at the ground station. Using a frame time of ten (10) msec, the UE receives the ground station signal delayed by twenty-five (25) frames from the time it was transmitted and the UE precesses its transmit time by fifty (50) frames so that it is twenty-five (25) ahead of the ground station signal at that instant (25-50) and then received with a zero frame offset twenty-five (25) frames later at the ground station after passing through the satellite. In general, the time adjustment by the UE will include frame, partial frame, bit and chip level adjustments. For example, using a ten (10) msec frame, one hundred (100) microsecond (μsec) bit, and one (1) μsec chip, a delay of approximately two-hundred and fifty one (251) msec corresponds to twenty-five (25) frames, eleven (11) bits and twelve (12) chips of offset.

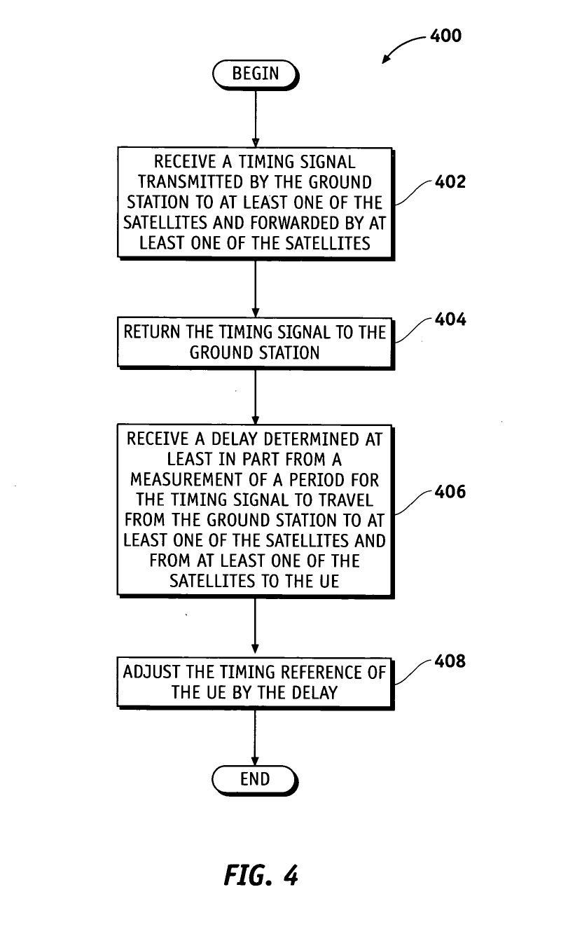

Referring to FIG. 4, a method 400 of operating the UE 104 of FIG. 2 is illustrated for synchronization in the MSS 100 in accordance with another exemplary embodiment of the present invention. As previously described with reference to the method 300 of FIG. 3, the method 400 is preferably conducted during the acquisition process (i.e., establishment of a communication link between the satellite and the UE), which can include registration with the MSS 100, call set-up procedures, answering call terminations and/or determining the correct downlink time-slot. However, the method 400 can be conducted at other operating intervals of the UE.

The method 400 includes a receiving a timing signal transmitted by a ground station and forwarded by at least one of the satellites of the constellation 402 and preferably forwarded by each of the satellites that forward the timing signal originating from the ground station. The timing signal preferably includes a reference time of the ground station and the timing signal is preferably received on the broadcast channel. However, the UE can receive the timing signal on other channels that are accessible by the UE and received by the ground station.

After receiving the timing signal transmitted by the ground station and forwarded by at least one satellite and preferably each of the satellites forwarding the timing signal to the UE, the method 400 continues with the UE returning the timing signal to the ground station 404. For example, the UE can transmit the unaltered timing signal and original reference time transmitted by the ground station, which is forwarded to the ground station by at least one of the satellites and preferably each of the satellites that originally forwarded the timing signal to the UE. The UE can use any number of the channels accessible by the UE that are received by the ground station, and preferably use a Random Access Channel (RACH).

Once the ground station receives the timing signal from the UE, the method 400 continues with receiving a delay that is determined based at least in part from a measurement of a period for the timing signal to originally travel from the ground station to at least one of the satellites, preferably each of the satellites that forward the timing signal, and from the one or more satellites forwarding the timing signal to the UE 406 to the ground station. For example, a substantially accurate calculation of the delay associated with the travel time of an electromagnetic wave from the ground station to the satellite and from the satellite to the ground station can be determined by subtracting the value of the timing reference of the ground station contained in the timing signal and the value of the timing reference of the ground station when the timing signal is returned from the UE and dividing this difference by two (2) as set forth in equation (5) as follows:
Delay =(T_{Transmit Time}−T_{Receive Time})/2 (5)
However other techniques can be used to calculate the delay associated with the travel time of an electromagnetic wave from the ground station to the satellite(s) and from the satellite(s) to the ground station in accordance with the present invention that are based at least in part from the measurement of the period for the timing signal to travel from the ground station to the satellite(s) and from the satellite(s) to the UE. In addition, other delay components can be included in the calculation of the delay, such as delays associated with activities of the ground station, satellite and/or UE. For example, the method 400 can include calculating the delay with a backend delay of the ground station 308. The delay can be calculated by the ground station or the two reference times can be transmitted to the satellite(s) and/or UE that can calculate the delay with the information received from the round trip travel of the timing signal. Once the delay has been received by the UE 406, the method 400 continues with the adjustment of the reference timing of the UE by the delay 408, such as the adjustment described with reference to the method 300 of FIG. 3.

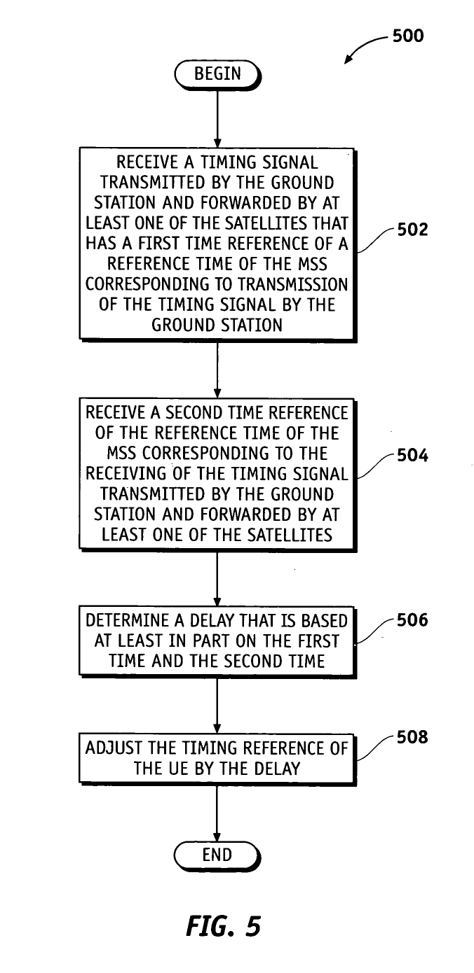

Referring to FIG. 5, a method 500 of operating the UE 104 of FIG. 2 is illustrated for synchronization in the MSS 100 in accordance with yet another exemplary embodiment of the present invention. As previously described with reference to the method 300 of FIG. 3 and method 400 of FIG. 4, the method 500 is preferably conducted during the acquisition process (i.e., establishment of a communication link between the satellite and the UE), which can include registration with the MSS 100, call set-up procedures, answering call terminations and/or determining the correct downlink time-slot. However, the method 500 can be conducted at other operating intervals of the UE.

The method 500 includes a receiving a timing signal, which has a first time of reference time of the MSS corresponding at least substantially to transmission of the timing signal by the ground station, that is transmitted by a ground station and forwarded by at least one of the satellites of the constellation and preferably forwarded by each of the satellites that forward the timing signal originating from the ground station 502. The timing signal is preferably received by the UE on the broadcast channel. However, the UE can receive the timing signal on other channels that are accessible by the UE and received by the ground station.

In addition to receiving the timing signal with the first reference time of the MSS 502, the method 500 also includes receiving a second time of reference time of the MSS corresponding at least substantially to reception of the timing signal by the UE 504. The reference time of the MSS used for the first time and second time can be any number of system reference times. For example, the UE and the ground station can be configured to receive GPS time from a GPS satellite of the GPS satellite constellation.

Once the UE has the first time and the second time, a delay is determined that is based at least in part from the first time and the second time 506. For example, a substantially accurate calculation of the delay associated with the travel time of an electromagnetic wave from the ground station to the satellite and from the satellite to the ground station can be determined by subtracting the value of the second time (T₂) (i.e., MSS system time at least substantially corresponding to the time that that the timing signal was received by the UE) from the first time (T₁) (i.e., MSS system time at least substantially corresponding to the time that the timing signal was transmitted by the ground station) as set forth in equation (6) as follows:
Delay =T₁−T₂ (6)
However other techniques can be used to calculate the delay associated with the travel time of an electromagnetic wave from the ground station to the satellite(s) and from the satellite(s) to the ground station in accordance with the present invention that are based at least in part on the first time and the second time. In addition, other delay components can be included in the calculation of the delay 508, such as delays associated with activities of the ground station, satellite and/or UE or the use of different time references with known offset. For example, the method 500 can include calculating the delay with a backend delay of the ground station. In another example, the ground station time reference could be offset from the time reference used by the UE and method 500 can include the step of calculating the delay with this offset. The delay can be calculated by the ground station or the two reference times can be transmitted to the satellite(s) and/or UE that can calculate the delay with the information received from the round trip travel of the timing signal. Once the delay has been received by the UE 506, the method 500 continues with UE, the reference timing of the UE is adjusted by the delay 508 such as the adjustment described with reference to the method 300 of FIG. 3.

The method 500 of FIG. 5, the method 300 of FIG. 3, and the method of FIG. 4 can be used individually, in combination, or in combination with methods not described in this detailed description to adjust the relative frame timing between the ground station and UE in a mobile satellite communication system. Accordingly, the relative frame timing between the ground station and UE in a mobile satellite communication system is known to a greater extent and a decrease in the uncertainty of the relative framing timing is provided in accordance with the present invention in addition to numerous other desirabilities.

In addition to decreasing the uncertainty of the relative framing, the MSS UE and the methods of operating the UE present significant benefits that would be apparent to one of ordinary skill in the art. Furthermore, while a preferred exemplary embodiment has been presented in the foregoing description of the drawings, it should be appreciated that a vast number of variations in the embodiments exist. Lastly, it should be appreciated that these embodiments are preferred exemplary embodiments only, and are not intended to limit the scope, applicability, or configuration of the invention in any way. Rather, the foregoing detailed description provides those skilled in the art with a convenient road map for implementing a preferred exemplary embodiment of the invention. It being understood that various changes may be made in the function and arrangement of elements described in the exemplary preferred embodiment without departing from the spirit and scope of the invention as set forth in the appended claims and the legal equivalents thereof.

1. A method of operating a User Equipment (UE) for synchronizing in a Mobile Satellite System (MSS) having a plurality of satellites and a ground station, comprising the steps of:
determining a position of the UE;
receiving information associated with a position of the satellite from a broadcast channel transmission of the ground station;
receiving a position of the ground station from said broadcast channel transmission of the ground station;
calculating a delay with said position of the UE, said information associated with said position of the satellite and said position of the ground station; and
adjusting a reference timing of the UE by said delay.

2. The method of operating the UE for synchronizing in a MSS having the plurality of satellites and the ground station of claim 1, further comprising the steps of:
receiving a backend delay of said ground station from said broadcast channel transmission of the ground station; and
calculating said delay with said position of the UE, said information associated with said position of the satellite, said position of the ground station and said backend delay of said ground station.

3. The method of operating the UE for synchronizing in a MSS having the plurality of satellites and the ground station of claim 1, further comprising calculating said position of the satellite based at least in part on said information associated with said position of the satellite.

4. The method of operating the UE for synchronizing in a MSS having the plurality of satellites and the ground station of claim 1, wherein said information associated with said position of the satellite are orbital parameters of said satellite.

5. The method of operating the UE for synchronizing in a MSS having the plurality of satellites and the ground station of claim 1, wherein said information associated with said position of the satellite is said position of the satellite.

6. The method of operating the UE for synchronizing in a MSS having the plurality of satellites and the ground station of claim 1, wherein said adjusting said reference timing of the UE by said delay advances said reference timing of the UE such that data transmitted by the UE substantially corresponds to a second reference timing of the ground station.

7. The method of operating the UE for synchronizing in a MSS having the plurality of satellites and the ground station of claim 1, wherein said broadcast channel transmission is a CDMA broadcast channel transmission.

8. The method of operating the UE for synchronizing in a MSS having the plurality of satellites and the ground station of claim 1, wherein said broadcast channel transmission is a WCDMA broadcast channel transmission.

9. The method of operating the UE for synchronizing in a MSS having the plurality of satellites and the ground station of claim 1, wherein said determining said position of the UE comprises receiving a GPS signal.

10. User Equipment (UE) that is configured for operation in a Satellite System (MSS), the MSS having a plurality of satellites that are configured to couple the UE to a ground station, comprising:
a transceiver that is configured to couple the UE to at least one of said plurality of satellites; and
a controller coupled to said transceiver, said controller configured to:
determine a position of the UE;
receive information associated with a position of the satellite from a broadcast channel transmission of the ground station;
receive a position of the ground station from said broadcast channel transmission of the ground station;
calculate a delay with said position of the UE, said information associated with said position of the satellite and said position of the ground station; and
adjust a reference timing of the UE by said delay.

11. The UE that is configured for operation in the MSS having the plurality of satellites that are configured to couple the UE to the ground station of claim 10, wherein said controller is further configured to receive a backend delay of said ground station from said broadcast channel transmission of the ground station and calculate said delay with said position of the UE, said information associated with said position of the satellite, said position of the ground station and said backend delay of said ground station.

12. The UE that is configured for operation in the MSS having the plurality of satellites that are configured to couple the UE to the ground station of claim 10, wherein said controller is further configured to calculate said position of the satellite based at least in part on said information associated with said position of the satellite.

13. The UE that is configured for operation in the MSS having the plurality of satellites that are configured to couple the UE to the ground station of claim 10, wherein said information associated with said position of the satellite are orbital parameters of said satellite.

14. The UE that is configured for operation in the MSS having the plurality of satellites that are configured to couple the UE to the ground station of claim 10, wherein said information associated with said position of the satellite is said position of the satellite.

15. The UE that is configured for operation in the MSS having the plurality of satellites that are configured to couple the UE to the ground station of claim 10, wherein said controller is configured to adjust said reference timing of the UE by said delay by advancing said reference timing of the UE such that data transmitted by the UE substantially corresponds to a second reference timing of the ground station.

16. The UE that is configured for operation in the MSS having the plurality of satellites that are configured to couple the UE to the ground station of claim 10, wherein said broadcast channel transmission is a CDMA broadcast channel transmission.

17. The UE that is configured for operation in the MSS having the plurality of satellites that are configured to couple the UE to the ground station of claim 10, wherein said broadcast channel transmission is a WCDMA broadcast channel transmission.

18. The UE that is configured for operation in the MSS having the plurality of satellites that are configured to couple the UE to the ground station of claim 10, wherein said controller is configured to determine said position of the UE with a GPS signal.

19. A method of operating a UE for synchronizing in a MSS having the plurality of satellites and the ground station, comprising the steps of:
receiving a timing signal transmitted by the ground station to at least one of the plurality of satellites and forwarded by said at least one of the plurality of satellites;
returning said timing signal to the ground station;
receiving a delay determined based in at least in part from a measurement of a period for said timing signal to travel from the ground station to the at least one of the plurality of satellites and from the at least one of said plurality of satellites to the UE; and
adjusting a reference timing of the UE by said delay.

20. The method of operating the UE for synchronizing in the MSS having the plurality of satellites and the ground station of claim 19, wherein said delay is determined by at least subtracting a first timing reference of the ground station contained in the timing signal from a second timing reference of the ground station associated with return of the timing signal to the ground station from the UE.

21. The method of operating the UE for synchronizing in the MSS having the plurality of satellites and the ground station of claim 19, further comprising the steps of:
determining a backend delay of said ground station; and
receiving said delay that is determined based in at least in part from backend delay.

22. The method of operating the UE for synchronizing in the MSS having the plurality of satellites and the ground station of claim 19, wherein said adjusting said reference timing of the UE by said delay advances said reference timing of the UE such that data transmitted by the UE substantially corresponds to a second reference timing of the ground station.

23. The method of operating the UE for synchronizing in the MSS having the plurality of satellites and the ground station of claim 19, wherein said delay is determined by said UE with data transmitted by said ground station.

24. The method of operating the UE for synchronizing in the MSS having the plurality of satellites and the ground station of claim 19, wherein said delay is determined by said ground station and transmitted to said UE.

25. User Equipment (UE) that is configured for operation in a Satellite System (MSS), the MSS having a plurality of satellites that are configured to couple the UE to a ground station, comprising:
a transceiver that is configured to couple the UE to at least one of said plurality of satellites; and
a controller coupled to said transceiver, said controller configured to:
receive a timing signal transmitted by the ground station to at least one of the plurality of satellites and forwarded by said at least one of the plurality of satellites;
return said timing signal to the ground station;
receive a delay determined based in at least in part from a measurement of a period for said timing signal to travel from the ground station to the at least one of the plurality of satellites and from the at least one of said plurality of satellites to the UE; and
adjust a reference timing of the UE by said delay.

26. The UE that is configured for operation in the MSS having a plurality of satellites that are configured to couple the UE to the ground station of claim 25, wherein said controller is configured to adjust said delay that is determined by at least subtracting a first timing reference of the ground station contained in the timing signal from a second timing reference of the ground station associated with return of the timing signal to the ground station from the UE.

27. The UE that is configured for operation in the MSS having a plurality of satellites that are configured to couple the UE to the ground station of claim 25, wherein said controller is further configured to:
determine a backend delay of said ground station; and
receive said delay that is determined based in at least in part from backend delay.

28. The UE that is configured for operation in the MSS having a plurality of satellites that are configured to couple the UE to the ground station of claim 25, wherein said controller is configured to adjust said reference timing of the UE by said delay by advancing said reference timing of the UE such that data transmitted by the UE substantially corresponds to a second reference timing of the ground station.

29. The UE that is configured for operation in the MSS having a plurality of satellites that are configured to couple the UE to the ground station of claim 25, wherein said delay is determined by said UE with data transmitted by said ground station.

30. The UE that is configured for operation in the MSS having a plurality of satellites that are configured to couple the UE to the ground station of claim 25, wherein said delay is determined by said ground station and transmitted to said UE.

31. A method of operating a UE for synchronizing in a MSS having a plurality of satellites and a ground station, comprising the steps of:
receiving a timing signal transmitted by the ground station and forwarded by at least one of the plurality of satellites, said timing signal having a first time of a reference time of the MSS corresponding to transmission of said timing signal by the ground station;
receiving a second time of said reference time of the MSS corresponding to said receiving said timing signal transmitted by the ground station and forwarded by at least one of the plurality of satellites;
determining a time delay that is based at least in part on said first time and said second time; and
adjusting a reference timing of the UE by said time delay.

32. A method of operating the UE for synchronizing in the MSS having the plurality of satellites and the ground station of claim 31, wherein said timing signal is received by the UE on a broadcast channel.

33. A method of operating the UE for synchronizing in the MSS having the plurality of satellites and the ground station of claim 31, wherein said reference time of the MSS is Global Positioning System (GPS) time.

34. A method of operating the UE for synchronizing in the MSS having the plurality of satellites and the ground station of claim 31, wherein determining said time delay that is based at least in part on said first time and said second time comprises subtracting said first time from said second time.

35. The method of operating the UE for synchronizing in the MSS having the plurality of satellites and the ground station of claim 31, further comprising the steps of:
receiving a backend delay of said ground station; and
determining said time delay with a delay that is based at least in part on said first time, said second time and said backend delay of said ground station.

36. User Equipment (UE) that is configured for operation in a Satellite System (MSS), the MSS having a plurality of satellites that are configured to couple the UE to a ground station, comprising:
a transceiver that is configured to couple the UE to at least one of said plurality of satellites; and
a controller coupled to said transceiver, said controller configured to:
receive a timing signal transmitted by the ground station and forwarded by at least one of the plurality of satellites, said timing signal having a first time of a reference time of the MSS corresponding to transmission of said timing signal by the ground station;
receive a second time of said reference time of the MSS corresponding to said receiving said timing signal transmitted by the ground station and forwarded by at least one of the plurality of satellites;
determine a time delay that is based at least in part on said first time and said second time; and
adjust a reference timing of the UE by said time delay.

37. The UE that is configured for operation in the MSS having the plurality of satellites that are configured to couple the UE to a ground station of claim 36, wherein said timing signal is received by the UE on a broadcast channel.

38. The UE that is configured for operation in the MSS having the plurality of satellites that are configured to couple the UE to a ground station of claim 36, wherein said reference time of the MSS is Global Positioning System (GPS) time.

39. The UE that is configured for operation in the MSS having the plurality of satellites that are configured to couple the UE to a ground station of claim 36, wherein said controller is configured to determine said time delay that is based at least in part on said first time and said second time by subtracting said first time from said second time.

40. The UE that is configured for operation in the MSS having the plurality of satellites that are configured to couple the UE to a ground station of claim 36, where said controller is further configured to:
receive a backend delay of said ground station; and
determine said time delay with a delay that is based at least in part on said first time, said second time and said backend delay of said ground station
